(19) United States
(12) Patent Application Publication
(10) Pub. No.: US 2026/0365093 A1
(43) Pub. Date: Nov. 19, 2026

(54) LUGGAGE GAP COVER DEVICE FOR VEHICLE REAR SEAT

(71) Applicants: Hyundai Motor Company, Seoul (KR); Kia Corporation, Seoul (KR); Lear Korea Limited Liability Company, Seoul (KR)

(72) Inventors: Sang Man SEO, Hwaseong-Si (KR); Ho Suk JUNG, Hwaseong-Si (KR); Soon Man JANG, Seoul (KR); Ryu Seok KO, Gwangmyeong-Si (KR); Byoung Su YOU, Siheung-Si (KR); Hyun Mok KIM, Seoul (KR)

(21) Appl. No.: 19/207,073

(22) Filed: May 13, 2025

(30) Foreign Application Priority Data
Oct. 22, 2024 (KR) 10-2024-0144670

(51) Int. Cl. B60N 2/60; B60R 7/04

(52) U.S. Cl. CPC B60N 2/6009; B60R 7/043

(57) ABSTRACT

A luggage gap cover device for a vehicle seat includes a first skirt support portion fixed on a front side of a luggage board, a second skirt support portion fixed to a seat or an upper rail to face the first skirt support portion, the second skirt support portion being movable in conjunction with movement of the seat along a movement path disposed on a lower rail, a skirt configured to cover a luggage gap disposed between the seat and the first skirt support portion when the seat is moved forwards along the movement path, and an elastic member extending from the skirt and fixed to a lower portion of a vehicle or the lower rail, the elastic member being configured to provide tension to the skirt.

### CROSS-REFERENCE TO RELATED APPLICATION

The present application claims priority to Korean Patent Application No. 10-2024-0144670, filed on Oct. 22, 2024, the entire contents of which is incorporated herein for all purposes by this reference.

### BACKGROUND OF THE PRESENT DISCLOSURE

### Field of the Present Disclosure

The present disclosure relates to a luggage gap cover device for a vehicle rear seat, and more particularly, to a luggage gap cover device for a vehicle rear seat configured for covering a gap between the rear seat slidably mounted in a vehicle and a luggage board.

### Description of Related Art

Generally, leisure vehicles (recreational vehicles (RVs), sports utility vehicles (SUVs), multi-purpose vehicles (MPVs), and the like) are provided with a luggage compartment in which loads may be loaded, and the luggage compartment is located at the rear side of the rear seats (second row seats or third row seats). The floor of the luggage compartment is formed of a luggage board, and a luggage tray capable of storing a spare tire, a tool, and the like is provided under the luggage board.

Furthermore, a storage space provided in the luggage tray may be opened or closed by opening and closing operations of the luggage board.

Typically, each of the rear seats (second row seats or third row seats) of a leisure vehicle is configured to perform a reclining function of reclining a seatback for angle adjustment of the seatback and a folding function of folding the seatback forwards.

To smoothly implement these reclining and folding functions, a predetermined space (gap) is secured between the front end of the luggage board and the seatback located adjacent to the luggage board.

Meanwhile, such a conventional structure has a disadvantage in that the predetermined space (gap) between the luggage board and the seatback of the rear seat is significantly large, which may cause deterioration in aesthetics or design quality of the vehicle interior.

In the conventional structure, an object may fall to a lower portion of the luggage board through the predetermined space (gap), and when the seatback of the rear seat is folded, it may be difficult to form the full flat surface between the rear seat and the luggage board due to the predetermined space formed therebetween.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a luggage gap cover device for a vehicle rear seat including a second skirt support portion disposed on the rear side of a seatback and a first skirt support portion fixedly disposed on a luggage board in a state of facing the second skirt support portion. When the rear seat is slidably moved forwards, a skirt positioned between the second skirt support portion and the first skirt support portion is deployed to cover a gap disposed between the rear seat and the luggage board, having an effect of improving the aesthetics or design quality of the vehicle interior.

In one aspect, the present disclosure provides a luggage gap cover device for a vehicle rear seat, the luggage gap cover device including a first skirt support portion fixed on a front side of a luggage board, a second skirt support portion fixed to a rear seat or an upper rail to face the first skirt support portion, the second skirt support portion being movable in conjunction with movement of the rear seat along a movement path disposed on a lower rail, a skirt configured to cover a luggage gap disposed between the rear seat and the first skirt support portion when the rear seat is moved forwards along the movement path, and an elastic member extending from the skirt and fixed to a lower portion of a vehicle or the lower rail, the elastic member being configured to provide tension to the skirt.

In an exemplary embodiment of the present disclosure, the skirt may be coupled to the rear seat to cover a gap disposed between the rear seat and the second skirt support portion and may be disposed to be selectively deployed when a seatback of the rear seat is folded in a predetermined direction.

In another exemplary embodiment of the present disclosure, the luggage gap cover device may further include a tension transfer guide member disposed on at least one of the rear seat, the upper rail, and the second skirt support portion, the tension transfer guide member being configured to guide a tension transfer path of the elastic member to provide the tension from the elastic member to the skirt.

In yet another exemplary embodiment of the present disclosure, the tension transfer guide member may be configured to prevent, when the rear seat is moved along the movement path, the elastic member from deviating from a position thereof.

In yet another exemplary embodiment of the present disclosure, the tension transfer guide member may be configured to change, when the rear seat is moved forwards or rearwards along the movement path, a position of supporting the elastic member to adjust the tension provided to the skirt.

In still yet another exemplary embodiment of the present disclosure, the tension transfer guide member may be configured, when the rear seat is moved rearwards along the movement path, to change the position of supporting the elastic member and to cause deformation of the elastic member to compensate for a decrease in the tension of the skirt, the decrease occurring when the rear seat is moved rearwards along the movement path.

In a further exemplary embodiment of the present disclosure, the second skirt support portion may include a second wire connected to a portion of the skirt, and a second wire support portion supporting the second wire.

In another further exemplary embodiment of the present disclosure, the first skirt support portion may include an elastic member support portion slidably supporting the elastic member to support elastic force of the elastic member.

In yet another further exemplary embodiment of the present disclosure, the first skirt support portion may include a skirt fixing portion restricting, when the rear seat is moved to a forwardmost position on the movement path, a deployment position of the skirt.

In yet another further exemplary embodiment of the present disclosure, the first skirt support portion may include an elastic member support portion slidably supporting the elastic member to support elastic force of the elastic member, and a skirt fixing portion restricting, when the rear seat is moved to a forwardmost position on the movement path, a deployment position of the skirt.

In still yet another further exemplary embodiment of the present disclosure, the first skirt support portion may include a first wire having a height corresponding to a height of the second wire, the first wire forming a deployment reference position of the skirt, and an elastic member support portion coupled to the first wire and supporting elastic force of the elastic member.

In a still further exemplary embodiment of the present disclosure, the skirt fixing portion may have a different height from a height of the elastic member support portion.

In a yet still further exemplary embodiment of the present disclosure, the skirt fixing portion may have a higher height than a height of the elastic member support portion.

In a yet exemplary embodiment of the present disclosure, the skirt may include a stopper selectively coupled to the skirt fixing portion.

In a yet further exemplary embodiment of the present disclosure, the skirt may be disposed of a material identical to a material of an upper surface of the luggage board.

Other aspects and exemplary embodiments of the present disclosure are discussed infra.

It is understood that the terms "vehicle", "vehicular", and other similar terms as used herein are inclusive of motor vehicles in general, such as passenger vehicles including sports utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a perspective view of a luggage gap cover device for a vehicle rear seat according to an exemplary embodiment of the present disclosure;

FIG. 2 is a side view of the luggage gap cover device for the vehicle rear seat according to the exemplary embodiment of the present disclosure;

FIG. 3 is view showing a state in which the rear seat is moved to the forwardmost position with respect to the luggage gap cover device for the vehicle rear seat according to the exemplary embodiment of the present disclosure;

FIG. 4 is a view showing a skirt in FIG. 3 of the luggage gap cover device for the vehicle rear seat according to an exemplary embodiment of the present disclosure;

FIG. 5 is a view showing a tension transfer guide member disposed on the luggage gap cover device for the vehicle rear seat according to the exemplary embodiment of the present disclosure; and

FIG. 6 is view showing a state in which the rear seat is moved to the rearmost position with respect to the luggage gap cover device for the vehicle rear seat according to the exemplary embodiment of the present disclosure; and

FIG. 7 is a view showing a skirt in FIG. 6 of the luggage gap cover device for the vehicle rear seat according to an exemplary embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, exemplary embodiments of the present disclosure will be described in detail with reference to the appended drawings.

Advantages and features of the present disclosure and methods of achieving the same will become more apparent with reference to the embodiments described below in detail.

However, the present disclosure is not limited by the embodiments described below and may be implemented in various forms. The embodiments are provided to ensure that the present disclosure is complete, and to fully inform the scope of the present disclosure to those skilled in the art to which the present disclosure pertains, and the present disclosure is only defined by the scope of the claims.

In describing the embodiments included herein, when it is determined that a detailed description of publicly known techniques to which the present disclosure pertains may obscure the gist of the present disclosure, detailed description thereof will be omitted.

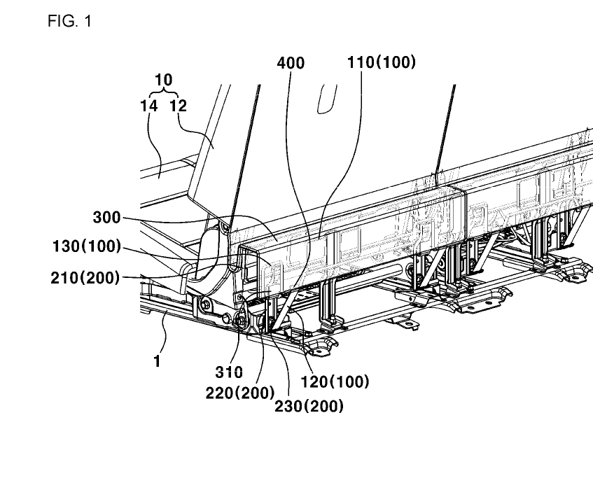

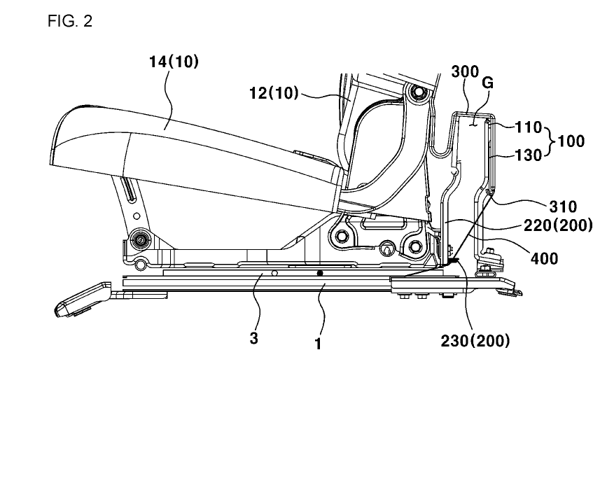

FIG. 1 is a perspective view of a luggage gap cover device for a vehicle rear seat according to an exemplary embodiment of the present disclosure, and FIG. 2 is a side view of the luggage gap cover device for the vehicle rear seat according to the exemplary embodiment of the present disclosure.

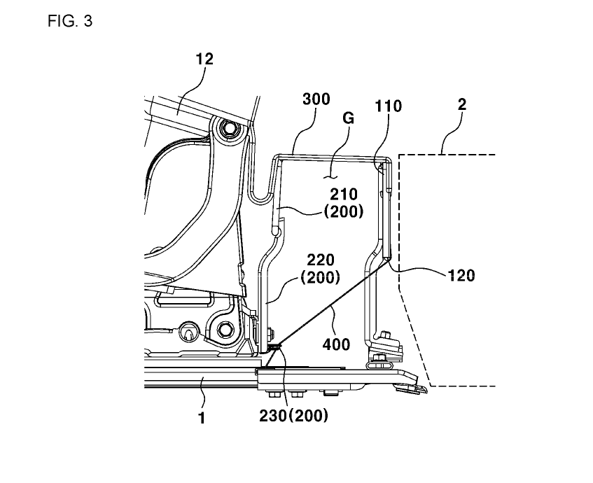

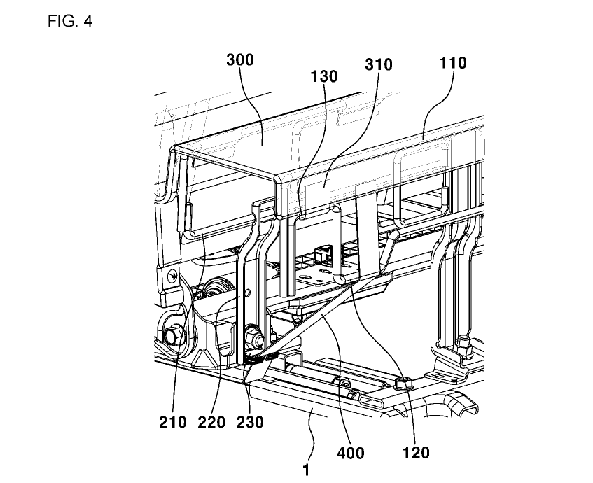

FIG. 3 is view showing a state in which the rear seat is moved to the forwardmost position with respect to the luggage gap cover device for the vehicle rear seat according to the exemplary embodiment of the present disclosure, and FIG. 4 is a view showing a skirt in FIG. 3 of the luggage gap cover device for the vehicle rear seat according to an exemplary embodiment of the present disclosure.

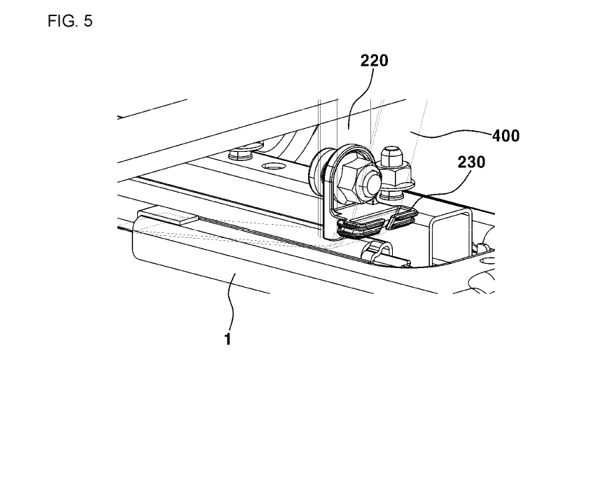

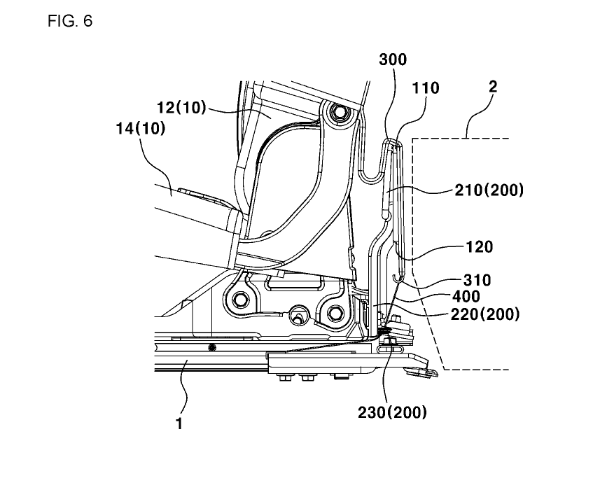

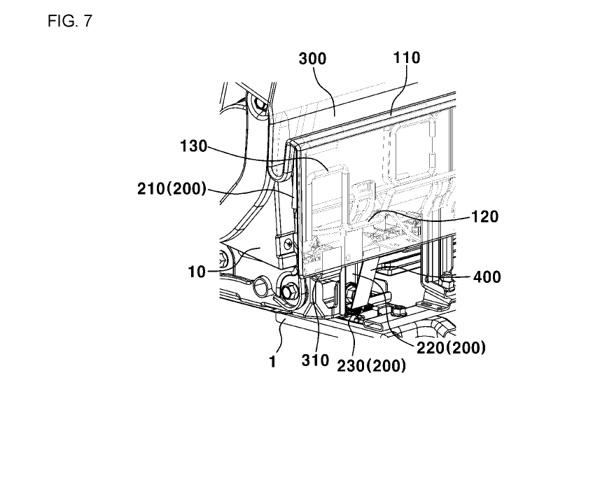

FIG. 5 is a view showing a tension transfer guide member disposed on the luggage gap cover device for the vehicle rear seat according to the exemplary embodiment of the present disclosure, FIG. 6 is view showing a state in which the rear seat is moved to the rearmost position with respect to the luggage gap cover device for the vehicle rear seat according to the exemplary embodiment of the present disclosure, and FIG. 7 is a view showing a skirt in FIG. 6 of the luggage gap cover device for the vehicle rear seat according to an exemplary embodiment of the present disclosure.

In general, to secure a rotation trajectory when a seatback 12 of a rear seat 10 is folded or unfolded, a minimally tuned luggage gap G is provided between the seatback 12 and a luggage compartment.

In detail, before the seatback 12 of the rear seat 10 is folded, the minimally tuned luggage gap G is provided between the back surface of the seatback 12 and a luggage board 2 forming the luggage compartment. The size of the luggage gap G is changed when the seatback 12 is folded or a seat cushion 14 is moved forwards or rearwards, and the luggage gap G is still present between the back surface of the seatback 12 and the luggage board.

Therefore, small objects, foreign substances, and the like may fall through the luggage gap G to the floor of the vehicle body. Furthermore, there is also a problem in that various types of dust and the like may pass through the luggage gap G, thereby leading to continuous accumulation of dust on the floor of the vehicle body.

Recently, the rear seat 10 in the second or third row of the vehicle is configured to be movable forwards and rearwards of the vehicle and to be foldable. As a result, the size of the luggage gap G may become large, and it is required to solve the above-described problem.

To the present end, the luggage gap cover device for the vehicle rear seat according to the exemplary embodiment of the present disclosure may include a first skirt support portion 100, a second skirt support portion 200, a skirt 300, and an elastic member 400 formed of elastic band, as shown in FIGS. 1 and 2.

Here, the elastic member 400 is described as being formed of a band, a strap or a fabric sheet made of rubber such as elastomers. However, the elastic member 400 is not limited thereto and may be implemented in various forms having elasticity.

The first skirt support portion 100 is fixedly positioned at the front side of the luggage board 2.

The first skirt support portion 100 is fixedly disposed upright on the rear side of a lower rail 1 configured to form a movement path of the rear seat 10 and is positioned on the front side of the luggage board 2 at a lower portion of the vehicle.

Furthermore, the second skirt support portion 200 is fixed to the rear seat 10 or an upper rail 3 in a state of facing the first skirt support portion 100, wherein the upper rail 3 is slidably engaged to the lower rail 1 and the rear seat 10 is fixed to the upper rail 3. In this structure, the second skirt support portion 200 is moved forwards or rearwards when the rear seat 10 fixed to the upper rail 3 is moved along the movement path disposed on the lower rail 1.

The second skirt support portion 200 is integrally connected to the rear seat 10 in a state of being spaced apart from the back surface of the seatback 12 by a predetermined gap.

Accordingly, when the rear seat 10 is moved forwards along the lower rail 1, the second skirt support portion 200 is also moved forwards. In the instant case, a gap G between the second skirt support portion 200 and the first skirt support portion 100 becomes increased due to the forward movement of the second skirt support portion 200, and the size of the luggage gap G gradually becomes large.

Here, one end portion of the skirt 300 is coupled to the back surface of the rear seat 10. Accordingly, when the rear seat 10 is moved forwards along the movement path of the rear seat 10, the skirt 300 is moved forwards and is selectively deployed in a state in which the other end portion of the skirt 300 is supported by the first skirt support portion 100, making it possible to cover the luggage gap G disposed between the first skirt support portion 100 and the second skirt support portion 200.

Here, the skirt 300 may maintain the shape thereof during deployment only when a certain amount of tension is maintained. Therefore, one end portion of the elastic member 400 is connected to the skirt 300, and the other end portion thereof is fixedly coupled to the lower portion of the vehicle or the lower rail 1. In the present manner, when the rear seat 10 is moved forwards along the movement path, the tension is provided to the deployed skirt 300, enabling the deployed skirt 300 to cover the luggage gap G in a state in which the tension of the skirt is tightly maintained.

The skirt 300 is formed of a material such as non-woven fabric, and more preferably, is formed of the same material as the upper surface material of the luggage board 2 forming the luggage compartment.

Meanwhile, the first skirt support portion 100 may be provided with a first wire 110 and an elastic member support portion 120.

The first wire 110 is disposed with a predetermined height at a position facing a second wire 210 and forms a reference position from which the skirt 300 is deployed.

The first wire 110 is disposed to have a height corresponding to a height of the second wire 210. When the rear seat 10 is moved forwards, the first wire 110 provides a reference point from which the skirt 300 is deployed horizontally to cover the luggage gap G at a predetermined height.

The elastic member support portion 120 is coupled to the first wire 110 and supports the elastic member 400 when the rear seat 10 is moved to the forwardmost position on the movement path.

That is, as shown in FIG. 3, when the rear seat 10 is moved to the forwardmost position on the movement path, a path of providing tension based on the elastic member support portion 120 is formed, and more specifically, the elastic member support portion 120 supports the elastic member 400 so that the tension provided through the elastic member 400 acts in the diagonal direction thereof.

Here, the first skirt support portion 100 may further include a skirt fixing portion 130 in addition to the elastic member support portion 120, as shown in FIG. 4.

The skirt fixing portion 130 has a different height from a height of the elastic member support portion 120 and is disposed to restrict the position at which the skirt 300 is deployed when the rear seat 10 is moved to the forwardmost position on the movement path. The skirt fixing portion 130 may have a higher height than that of the elastic member support portion 120.

The skirt 300 may be provided with a stopper 310 disposed to have a hook shape to be selectively hooked to the skirt fixing portion 130.

Here, when the rear seat 10 reaches the forwardmost position on the movement path in a state in which the skirt 300 is deployed in the horizontal direction, the elastic member 400 pulls the skirt 300 with the set maximum tension. At the instant time, since the stopper 310 is disposed to have the hook shape to be hooked to the skirt fixing portion 130, the skirt 300 may be prevented from sagging when external force or the like is applied to the skirt.

In other words, when the skirt 300 in the deployed state is pressed by any external force, a pressed portion of the skirt may sag. However, in the instant case, while the maximum tension set by the elastic member 400 is provided to the skirt 300, the stopper 310 is fixed in a state of being caught by the skirt fixing portion 130. Accordingly, the stopper 310 may prevent the skirt 300 from being pulled by a sagging length of the pressed portion. In the present manner, sagging of the skirt 300 may be prevented.

The skirt fixing portion 130 is disposed to have a lower height than that of the first wire 110 (refer to FIGS. 4 and 7), but the present disclosure is not limited thereto. The skirt fixing portion 130 may have the same height as that of the first wire 110 when the movement path allowing the rear seat 10 to be moved to the forwardmost position becomes longer.

The second skirt support portion 200 may be provided with a second wire 210 and a second wire support portion 220.

The second wire 210 is disposed to have a width length corresponding to a width length of the back surface of the rear seat 10, as shown in FIG. 1. Furthermore, the second wire 210 is fixed to the skirt 300 attached to the rear seat 10 using an adhesive or the like.

When the seatback 12 is folded, the skirt 300 between the rear seat 10 and the second wire 210 is pulled by the rotating seatback 12 so that the skirt is deployed in an approximately flat shape. Accordingly, an area of the skirt 300 covering the luggage gap G and the upper surface of the luggage board 2 may be arranged in a straight line.

Therefore, through the present arrangement, when the rear seat 10 is folded so that the skirt becomes fully flat, the skirt may provide effective space utilization.

Furthermore, the second wire support portion 220 is disposed to have a predetermined height and supports the second wire 210 in a state of being spaced apart from the back surface of the rear seat 10 so as not to interfere with the rotating seatback 12.

Meanwhile, the luggage gap cover device for the vehicle rear seat according to the exemplary embodiment of the present disclosure may further include a tension transfer guide member 230.

The tension transfer guide member 230 may be disposed on at least one of the rear seat 10, the upper rail 3, and the second skirt support portion 200, so as to move with the rear seat 10 and to provide a tension transfer path of the elastic member 400 to appropriately transfer the tension from the elastic member 400 to the skirt 300 in response to the movement of the rear seat 10.

As shown in FIG. 5, the tension transfer guide member 230 is disposed as a slot structure configured to allow the elastic member 400 to move through an inside of the slot structure. Accordingly, even if the rear seat 10 is moved, the position of the elastic member 400 may not be changed by the tension transfer guide member 230.

The tension transfer guide member 230 is configured to prevent, when the rear seat 10 is moved along the movement path, the elastic member 400 from deviating from the position thereof. When the rear seat 10 is moved forwards or rearwards along the movement path, the tension transfer guide member 230 changes the position thereof to support the elastic member 400, appropriately adjusting the tension to be applied to the skirt 300.

That is, as shown in FIG. 3, the tension transfer guide member 230 provides the maximum tension set to the skirt 300 when the rear seat 10 is moved to the forwardmost position on the movement path.

Furthermore, as shown in FIG. 6, the tension transfer guide member 230 changes the position to support the elastic member 400 when the rear seat 10 is moved to the rearmost position on the movement path. Accordingly, the shape of the elastic member 400 is changed to compensate for a decrease in the tension of the skirt 300 that occurs when the rear seat 10 is moved rearwards on the movement path.

In other words, as shown in FIG. 4, when the rear seat 10 is moved to the forwardmost position on the movement path in a state in which the stopper 310 is fixedly coupled to the skirt fixing member 130, the tension transfer guide member 230 allows the position of the elastic member 400 to be fixed to support the elastic member 400 in the direction of pulling the elastic member. In the present manner, the tension provided from the elastic member 400 is maximally applied to the skirt.

Furthermore, as shown in FIG. 7, when the rear seat 10 is moved to the rearmost position on the movement path, the tension transfer guide member 230 allows the position of the elastic member 400 to be fixed to support the elastic member 400 in the direction of pushing the elastic member. In the present manner, the tension provided from the elastic member 400 is minimally applied to the skirt.

When the rear seat 10 is moved to the forwardmost position, the tension transfer guide member 230 supports the elastic member 400 in the direction of pulling the elastic member to allow the elastic member 400 to have the maximum length. In the present manner, the tension provided from the elastic member 400 is maximally applied to the skirt. On the other hand, when the rear seat 10 is moved to the rearmost position, the tension transfer guide member 230 supports the elastic member 400 in the direction of pushing the elastic member to allow the elastic member 400 to have the minimum length. In the present manner, the tension provided from the elastic member 400 is minimally applied to the skirt.

Accordingly, since the tension transfer guide member 230 and the elastic member 400 may provide tension at all movement positions of the rear seat 10, sagging of the skirt 300 may be prevented. As a result, regardless of the movement position of the rear seat 10, in other words, regardless of a change in the size of the luggage gap G, the luggage gap G may be covered by the skirt 300 using the tension provided from the tension transfer guide member 230 and the elastic member 400, making it possible to effectively secure the aesthetics or design quality of the vehicle interior.

The present disclosure includes a second skirt support portion disposed on the rear side of a seatback, and a first skirt support portion fixedly disposed on a luggage board in a state of facing the second skirt support portion. When a rear seat is slidably moved forwards, a skirt positioned between the second skirt support portion and the first skirt support portion is deployed to cover a gap disposed between the rear seat and the luggage board, having an effect of improving the aesthetics or design quality of the vehicle interior.

Additionally, the skirt and a lower rail are connected to each other by an elastic member, having an effect of maintaining tension when the skirt is deployed and covering the gap disposed between the rear seat and the luggage board.

Furthermore, even if the rear seat is moved to the forwardmost position on the movement path, a stopper provided on the skirt is positioned in a state of being caught by the first skirt support portion to maintain the tension of the skirt. Accordingly, when the rear seat is folded to form the full flat surface between the rear seat and the luggage board, the present disclosure has an effect of maximally utilizing the space of a luggage compartment.

As is apparent from the above description, the present disclosure provides a luggage gap cover device for a vehicle rear seat including a second skirt support portion disposed on the rear side of a seatback, and a first skirt support portion fixedly disposed on a luggage board in a state of facing the second skirt support portion. When a rear seat is slidably moved forwards, a skirt positioned between the second skirt support portion and the first skirt support portion is deployed to cover a gap disposed between the rear seat and the luggage board, having an effect of improving the aesthetics or design quality of the vehicle interior.

Furthermore, an elastic member is provided to connect the skirt to a lower rail, including an effect of not only maintaining tension when the skirt is deployed, but also covering the gap disposed between the rear seat and the luggage board.

Furthermore, even if the rear seat is moved to the forwardmost position on the movement path, a stopper provided on the skirt is positioned in a state of being caught by the first skirt support portion, having an effect of maintaining the tension of the skirt. Accordingly, when the rear seat is folded to form the full flat surface between the rear seat and the luggage board, the luggage gap cover device has an effect of maximally utilizing the space of a luggage compartment.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as "include" or "have" is intended to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A luggage gap cover apparatus for a vehicle seat, the luggage gap cover apparatus comprising:
a first skirt support portion fixed on a front side of a luggage board;
a second skirt support portion fixed to a vehicle seat or an upper rail to which the vehicle seat is fixed, to face the first skirt support portion, the second skirt support portion being movable in conjunction with movement of the vehicle seat along a movement path formed on a lower rail fixed to a vehicle and slidably engaged to the upper rail;
a skirt covering a luggage gap disposed between the first skirt support portion and the second skirt support portion based on that the vehicle seat is moved in a first direction along the movement path; and
an elastic member extending from a first end portion of the skirt and fixed to a lower portion of the vehicle or the lower rail, the elastic member being configured to provide tension to the skirt.

2. The luggage gap cover apparatus of claim 1, wherein a second end portion of the skirt is coupled to the vehicle seat to cover a gap disposed between the vehicle seat and the second skirt support portion and is selectively deployed based on that a vehicle seatback of the vehicle seat is folded in the first direction.

3. The luggage gap cover apparatus of claim 1, further including a tension transfer guide member disposed on at least one of the vehicle seat, the upper rail, and the second skirt support portion and slidably engaged to the elastic member, the tension transfer guide member being configured to guide a tension transfer path of the elastic member to provide the tension from the elastic member to the skirt.

4. The luggage gap cover apparatus of claim 3, wherein the tension transfer guide member is configured to prevent, based on that the vehicle seat is moved along the movement path, the elastic member from deviating from the tension transfer guide member.

5. The luggage gap cover apparatus of claim 3, wherein the tension transfer guide member is configured to change, based on that the vehicle seat is moved in the first direction or in a second direction along the movement path, a position of supporting the elastic member to adjust the tension provided to the skirt.

6. The luggage gap cover apparatus of claim 5, wherein the tension transfer guide member is configured, based on that the vehicle seat is moved in the second direction along the movement path, to:
change the position of supporting the elastic member; and
cause deformation of the elastic member to compensate for a decrease in the tension of the skirt, the decrease occurring based on that the vehicle seat is moved in the second direction along the movement path.

7. The luggage gap cover apparatus of claim 1, wherein the second skirt support portion includes:
a second wire connected to a portion of the skirt; and
a second wire support portion fixed to the vehicle seat or the upper rail and supporting the second wire.

8. The luggage gap cover apparatus of claim 1, wherein the first skirt support portion includes an elastic member support portion slidably supporting the elastic member to support elastic force of the elastic member.

9. The luggage gap cover apparatus of claim 1, wherein the first skirt support portion includes a skirt fixing portion restricting, based on that the vehicle seat is moved to a forwardmost position in the first direction on the movement path, a deployment position of the skirt.

10. The luggage gap cover apparatus of claim 9, wherein the skirt includes a stopper selectively coupled to the skirt fixing portion according to the deployment movement of the vehicle seat.

11. The luggage gap cover apparatus of claim 1, wherein the first skirt support portion includes:
an elastic member support portion slidably supporting the elastic member to support elastic force of the elastic member; and
a skirt fixing portion selectively coupled to the skirt for restricting, based on that the vehicle seat is moved to a forwardmost position in the first direction on the movement path, a deployment position of the skirt.

12. The luggage gap cover apparatus of claim 11, wherein a second end portion of the skirt includes a stopper selectively coupled to the skirt fixing portion according to the deployment movement of the vehicle seat.

13. The luggage gap cover apparatus of claim 7, wherein the first skirt support portion includes:
a first wire having a height corresponding to a height of the second wire, the first wire forming a deployment reference position of the skirt; and
an elastic member support portion coupled to the first wire and slidably supporting the elastic member to support elastic force of the elastic member.

14. The luggage gap cover apparatus of claim 13, wherein the first skirt support portion further includes:
a skirt fixing portion selectively coupled to a stopper of the skirt for restricting, based on that the vehicle seat is moved to a forwardmost position in the first direction on the movement path, a deployment position of the skirt.

15. The luggage gap cover apparatus of claim 14,
wherein the first wire has a height corresponding to a height of the second wire,
wherein the skirt fixing portion has a height lower than the first wire and higher than the elastic member support portion.

16. The luggage gap cover apparatus of claim 11, wherein the skirt fixing portion has a different height from a height of the elastic member support portion.

17. The luggage gap cover apparatus of claim 16, wherein the skirt fixing portion has a higher height than a height of the elastic member support portion.

18. The luggage gap cover apparatus of claim 8, wherein the skirt includes a stopper selectively coupled to the skirt fixing portion.

19. The luggage gap cover apparatus of claim 1, wherein the skirt is formed of a material identical to a material of an upper surface of the luggage board.
